(19) United States
(12) Patent Application Publication
(10) Pub. No.: US 2011/0004447 A1
(43) Pub. Date: Jan. 6, 2011

(54) Method to build 3D digital models of porous media using transmitted laser scanning confocal mircoscopy and multi-point statistics

(75) Inventors: Neil Francis Hurley, Boston, MA (US); Tuanfeng Zhang, Lexington, MA (US); Weishu Zhao, Quincy, MA (US); Guangping Xu, Fort Collins, CO (US)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/459,414

(22) Filed: Jul. 1, 2009

(51) Int. Cl. G06G 7/57; G06F 17/50; G06K 9/00; G06F 17/18

(52) U.S. Cl. 703/1; 382/154; 702/179; 703/9

(57) ABSTRACT

Methods for characterizing a three-dimensional (3D) sample of porous media using at least one measuring tool that retrieves two or more set of transmitted measured data at two or more depths of the sample, such that the retrieved two or more set of transmitted measured data is communicated to a processor and computed in at least one multi-point statistical (MPS) model.

### BACKGROUND OF THE INVENTION

1. Field of the Invention

The present invention generally relates to methods for characterizing a three-dimensional (3D) sample of porous media. In particular, a method using at least one measuring tool that retrieves two or more set of transmitted measured data at two or more depths of the sample, such that the retrieved two or more set of transmitted measured data is communicated to a processor and computed in at least one multi-point statistical (MPS) model so as to characterize the three-dimensional (3D) sample of porous media.

2. Background of the Invention

Confocal microscopy can be defined as a technique for obtaining high resolution images and three dimensional (3-D) reconstructions of biological specimens; a laser light beam is expanded to make optimal use of the optics in the objective lens and is turned into a scanning beam via an x-y deflection mechanism and is focused to a small spot by the objective lens onto a fluorescent specimen. The mixture of reflected light and emitted fluorescent light is captured by the same objective and after conversion into a static beam by the x-y scanner device is focused onto a photodetector (photomultiplier) via a dichroic mirror (beam splitter) to create the final image. Called also laser scanning microscopy; confocal scanning laser microscopy.

The principle of confocal imaging was patented by Marvin Minsky (see U.S. Pat. No. 3,013,467 issued to Minsky, M., 1961). In a conventional (i.e., wide-field) fluorescence microscope, the entire specimen is flooded in light from a light source. Due to the conservation of light intensity transportation, all parts of the specimen throughout the optical path will be excited and the fluorescence detected by a photodetector or a camera. In contrast, a confocal microscope uses point illumination and a pinhole in an optically conjugate plane in front of the detector to eliminate out-of-focus information. Only the light within the focal plane can be detected, so the image quality is much better than that of wide-field images. As only one point is illuminated at a time in confocal microscopy, 2D or 3D imaging requires scanning over a regular raster (i.e., a rectangular pattern of parallel scanning lines) in the specimen. The thickness of the focal plane can be defined mostly by the square of the numerical aperture of the objective lens, and also by the optical properties of the specimen and the ambient index of refraction (see Wikipedia (2009)).

Referring to FIGS. 1-3, confocal microscopy is widely used in the life sciences and semiconductor industries. Some related references include Stevens et al. (1994), Matsumoto (2002), Pawley (2006), Nikon (2009), and Olympus (2009) (see Stevens, J. K., Mills, L. R., and Trogadis, J. E., 1994, Three-dimensional confocal microscopy: Volume investigation of biological specimens: Academic Press, San Diego, Calif., 506 p.; Matsumoto, B., 2002, Cell biological applications of confocal microscopy: Academic Press, San Diego, Calif., 2^{nd} edition, 499 p.; Pawley, J. B., 2006, Handbook of biological confocal microscopy: Springer, New York, N.Y., 3^{rd} edition, 985 p.; Nikon, 2009, http://www.microscopyu.com/articles/confocal/index.html, accessed on March 30; and Olympus, 2009, http://www.olympusconfocal.com/theory/confocalintro.html, accessed on March 30). FIG. 1 shows the basic principles of confocal microscopy, in particular, features that include detector pinhole and parallel focal planes at different levels in the specimen. (see Olympus (2009). FIGS. 2 and 3 provide schematic and real comparisons of conventional widefield vs. confocal microscopy. In particular, FIG. 2 shows a comparison of conventional widefield (left) vs. confocal (right) microscopy. The confocal image is a high-resolution measurement of a single focused point on the specimen (see Olympus (2009)). FIG. 3 shows images of biological specimens as shown in comparison between conventional widefield (top) vs. confocal (bottom) microscopy (see Olympus (2009)).

Still referring to FIGS. 1-3, confocal microscopy is not commonly used in the earth sciences. Fredrich et al. (1995) and Fredrich (1999) created 3D images of rocks using transmitted LSCM. O'Connor and Fredrich (1999) did flow experiments on these numerical rocks using lattice-Boltzmann methods (see Fredrich, J. T., 1999, 3D imaging of porous media using laser scanning confocal microscopy with application to microscale transport processes: Physics and Chemistry of the Earth, Part A: Solid Earth and Geodesy, v. 24, Issue 7, p. 551-561); and O'Connor, R. M., and Fredrich, J. T., 1999, Microscale flow modeling in geologic materials: Physics and Chemistry of the Earth, Part A: Solid Earth and Geodesy, v. 24, Issue 7, p. 611-616). Li and Wan (1995) used LSCM to image asphaltene particles (see Li, H., and Wan, W. K., 1995, Investigation of the asphaltene precipitation process from Cold Lake bitumen by confocal scanning laser microscopy: SPE Preprint 30321, Presented at the International Heavy Oil Symposium, Calgary, Alberta, Canada, June 19-21). Reid and McIntyre (2001) used LSCM to image small pores (1 to 10 microns) in porcelanites in the Monterey Formation in California (see Reid, S. A., and McIntyre, J. L., 2001, Monterey Formation porcelanite reservoirs of the Elk Hills field, Kern County, California: AAPG Bulletin, v. 85, p. 169-189).

Transmitted laser scanning confocal microscopy (LSCM) are commercially available. As an example, the Leica TCS SP5 is a device that is useful for earth science applications. The user defines the x-y grid; the minimum step distance in the x-y direction is 15 nm and the minimum step distance in the z direction is 3 nm. The device uses argon lasers with wavelengths of 458, 476, 488, and 514 nm, and helium-neon lasers with wavelengths of 543 and 633 nm.

Depth of penetration of LSCM is limited because reflected light intensity is attenuated with depth. Attenuation is caused by absorption and scattering by the material above the focal plane. Fredrich (1999) stated that optical sectioning depths in rock samples ranged from 50 to 250μ, depending on the nature of the imaged material.

Digital Models of Rocks and Pores

The published literature has examples of numerical rock models built using various techniques, including reconstructions made from 2D thin sections or scanning-electron microscope (SEM) images, computer-generated sphere packs, and various types of CTscans (conventional, microCT, and synchrotron-computed microtomography).

Bakke and Oren (1997), Oren et al. (1998), and Oren and Bakke (2002) developed a technique that constructs 3D pore systems from 2D thin sections (see Bakke, S., and Oren, P.-E., 1997, 3-D pore-scale modeling of sandstones and flow simulations in the pore networks: SPE preprint 35,479, European 3-D Reservoir Modeling Conference, Stavanger, Norway, April 16-17, p. 136-149; Oren, P.-E., Bakke, S., and Amtzen, O. J., 1998, Extending predictive capabilities to network models: SPE Journal, v. 3, p. 324; Oren, P.-E., and Bakke, S., 2002, Process based reconstruction of sandstones and prediction of transport properties: Transport in Porous Media, v. 46, p. 311-343). Wu et al. (2006) presented a method to generate 3D numerical rock models from 2D thin sections using a third-order Markov mesh (see Wu, K., Van Dijke, M. I. J., Couples, G. D., Jiang, Z., Ma, J., Sorbie, K. S., Crawford, J., Young, I., and Zhang, X., 2006, 3D stochastic modelling of heterogeneous porous media—Applications to reservoir rocks: Transport in Porous Media, v. 65, p. 443-467). Okabe and Blunt (2004, 2005) generated 3D images from 2D thin sections using multi-point statistics (see Okabe, H., and Blunt, M. J., 2004, Prediction of permeability for porous media reconstructed using multiple-point statistics: Physical Review E, v. 70, p. 066135-1-10; and Okabe, H., and Blunt, M. J., 2005, Pore space reconstruction using multiple-point statistics: Journal of Petroleum Science and Engineering, v. 46, p. 121-137). Tomutsa and Radmilovic (2003, 2007) used ion-beam thinning to create multiple 2D serial sections that they used to build 3D models of sub-micron scale pores (see Tomutsa, L., and Radmilovic, V., 2003, Focused ion beam assisted three-dimensional rock imaging at submicron scale: International Symposium of the Soc. of Core Analysts, Pau, France, September 21-24, Paper SCA2003-47; and Tomutsa, L., and Radmilovic, V., 2007, Analysis of chalk petrophysical properties by means of submicron-scale pore imaging and modeling: SPE Reservoir Evaluation and Engineering, v. 10, p. 285-293).

Dvorkin et al. (2003) described Digital Rock Physics technology, which consists of pore-scale numerical simulations derived from: (a) 2D thin sections and statistical-indicator simulation, or (b) CTscans. They built 3D models of virtual rock, and did flow simulations using the lattice-Boltzmann method (see Dvorkin, J., Kameda, A., Nur, A., Mese, A., and Tutuncu, A. N., 2003, Real time monitoring of permeability, elastic moduli and strength in sands and shales using Digital Rock Physics: SPE preprint 82246, presented at the SPE European Formation Damage Conference, The Hague, Netherlands, May 13-14, 7 p.).

Creusen et al. (2007) and Vahrenkamp et al. (2008) described mini-models, i.e., reservoir models that are less than 1.0 m³ in size and provide pseudo-properties for volume cells in reservoir-scale models (see Creusen, A., Maamari, K., Tull, S., Vahrenkamp, V., Mookerjee, A., and van Rijen, M., 2007, Property modeling small scale heterogeneity of carbonate facies: SPE Preprint 111451, Presented at Reservoir Characterization and Simulation Conference, Abu Dhabi, U.A.E., 28-31 October; and Vahrenkamp, V. C., Creusen, A., Tull, S., Farmer, A., Mookerjee, A. and Al Bahry, A., 2008, Multi-scale heterogeneity modelling in a giant carbonate field, northern Oman (abs.): GeoArabia, v. 13, No. 1, p. 248). Mini-models are populated using “principle rock types” (PRT), which “cover and categorize the full range of pore types, sizes, pore-throat size distributions, capillary entry pressures, relative permeabilities, etc.” PRT's are organized into “rock type associations” (RTA), which are based on “sedimentary fabric” determined from borehole-image logs. RTA's are distributed in the reservoir using borehole-image logs, and observed layering, facies models, and seismic data.

Bryant et al. (1993) and Behseresht et al. (2007) described digital rock models that are computer-generated dense random periodic packings of spheres (see Bryant, S., Mellor, D., and Cade, C., 1993, Physically representative network models of transport in porous media: American Institute of Chemical Engineers Journal, v. 39, No. 3, p. 387-396; and Behseresht, J., Bryant, S. L., and Sepehrnoori, K., 2007, Infinite-acting physically representative networks for capillarity-controlled displacements: SPE preprint 110581, presented at the SPE Annual Technical Conference and Exhibition, Anaheim, Calif., November 11-14, 15 p.). Other workers, such as Bosl et al. (1998) and Holt (2001) generated similar digital rock models for flow experiments (see Bosl, W. J, Dvorkin, J., and Nur, A., 1998, A study of porosity and permeability using a lattice-Boltzmann simulation: Geophysical Research Letters, v. 25, p. 1475-1478; and Holt, R. M., 2001, Particle vs. laboratory modelling in in situ compaction: Physics and Chemistry of the Earth, Part A: Solid Earth and Geodesy, v. 26, Issue 1-2, p. 89-93).

The most common way to generate pore systems is from various types of CTscans. Vinegar (1986), Wellington and Vinegar (1987), and Withjack et al. (2003) summarized the technology and discussed applications of X-ray computed tomography (see Vinegar, H. J., 1986, X-ray CT and NMR imaging of rocks: JPT, p. 257-259; Wellington, S. L., and Vinegar, H. J., 1987, X-ray computerized tomography: JPT, p. 885-898; and Withjack, E. M., Devier, C., and Michael, G., 2003, The role of X-ray computed tomography in core analysis: SPE preprint 83467, presented at the Western Region/AAPG Pacific Section Joint Meeting, Long Beach, Calif., May 19-24, 2003, 12 p.). Knackstedt et al. (2004), Siddiqui and Khamees (2005), and Siddiqui et al. (2005) emphasized the use of 3D images of cores and cuttings from conventional and microCTscans (see Knackstedt, M. A., Arns, C. H., Sakellariou, A., Senden, T. J., Sheppard, A. P., Sok, R. M., Pinczewski, W. V., and Bunn, G. F., 2004, Digital core laboratory: Properties of reservoir core derived from 3d images: SPE Preprint 87009, Presented at the Asia-Pacific Conference on Integrated Modelling for Asset Management, March 29-30; Siddiqui, S., and Khamees, A. A., 2005, Data visualization challenges for displaying laboratory core and flow data in three-dimensions: SPE preprint 106334, presented at the SPE Technical Symposium of Saudi Arabia, May 14-16, 9 p.; and Siddiqui, S., Grader, A. S., Touati, M., Loermans, A. M., and Funk, J. J., 2005, Techniques for extracting reliable density and porosity data from cuttings: SPE preprint 96918, presented at the SPE Annual Technical Conference and Exhibition, Dallas, Tex., October 9-12, 13 p.).

Coles et al. (1996), Fredrich et al. (2006), and Fredrich et al. (2007) used synchrotron-computed microtomography to build numerical 3D models of pore systems in natural and synthetic sandstones (see Coles, M. E., Hazlett, R. D., Muegge, R. L., Jones, K. W., Andrews, B. Dowd, B. Siddons, P., Peskin, A., Spanne, P., and Soll, W. E., 1996, Developments in synchrotron X-ray microtomography with applications to flow in porous media: SPE preprint 36531, presented at the SPE Annual Technical Conference and Exhibition, Denver, Colo., p. 413-424; Fredrich, J. T., DiGiovanni, A. A., and Noble, D. R., 2006, Predicting macroscopic transport properties using microscopic image data: Journal of Geophysical Research B: Solid Earth, v. 111, Issue 3; and Fredrich, J. T., Haney, M. M., and White, J. A., 2007, Predicting petrophysical properties using 3D image data (abs.): AAPG Annual Convention, downloaded at http://www.aapg.org). They used lattice-Boltzmann methods to model permeability. Zhang et al. (2005) generated conventional CTscan images of a vuggy limestone, and performed flow simulations (see Zhang, L., Nair, N., Jennings, J. W., and Bryant, S. L., 2005, Models and methods for determining transport properties of touching-vug carbonates: SPE preprint 96027, presented at the SPE Annual Technical Conference and Exhibition, Dallas, Tex., October 9-12, 9 p.). Kayser et al. (2004, 2006) showed how conventional and microCTscans can be used to image rocks and pores in 3D (see Kayser, A., Gras, R., Curtis, A., and Wood, R., 2004, Visualizing internal rock structures: Offshore, v. 64, No. 8, p. 129-131; and Kayser, A., Knackstedt, M., and Ziauddin, M., 2006, A closer look at pore geometry: Oilfield Review, v. 18, No. 1, p. 4-13).

Multipoint Statistics

Multipoint (or multiple-point) statistical methods (MPS) are a new family of spatial statistical interpolation algorithms proposed in the 1990s that are used to generate conditional simulations of discrete variable fields, such as geological facies, through training images (see Guardiano, F., and Srivastava, R. M. 1993, Multivariate geostatistics: Beyond bivariate moments: Geostatistics-Troia, A. Soares. Dordrecht, Netherlands, Kluwer Academic Publications, v. 1, p. 133-144). MPS is gaining popularity in reservoir modeling because of its ability to generate realistic models that can be constrained by different types of data. Unlike the conventional 2-point or variogram-based geostatistical approaches, MPS uses a training image to quantify the complex depositional patterns believed to exist in studied reservoirs. These training patterns are then reproduced in the final MPS models with conditioning to local data collected from the reservoirs. Therefore, MPS allows modelers to use their prior geological interpretations as conceptual models (training images) in the reservoir modeling process and to evaluate the uncertainty associated with the prior interpretations by using different training images.

In addition to categorical variables, MPS can also be used to deal with continuously variable training images, such as spatial distribution of porosity. Two families of MPS algorithms are available to handle these different types of training images: Snesim for categorical variables, and Filtersim for continuous variables. Strebelle (2002) proposed an efficient Snesim algorithm that introduced the concept of a search tree to store all replicates of patterns found within a template over the training image (see Strebelle, S. 2002, Conditional simulation of complex geological structures using multiple point statistics: Mathematical Geology, v. 34, p. 1-22). This makes Snesim code several orders of magnitude faster than the original algorithm proposed by Guardiano and Srivastava (1993). Filtersim, developed by Zhang (2006), applies a set of local filters to the training image, which can be either categorical or continuous, to group local patterns into pattern classes. Pattern simulation then proceeds on the basis of that classification (see Zhang, T. 2006, Filter-based training image pattern classification for spatial pattern simulation. PhD dissertation, Stanford University, Palo Alto, Calif.).

Snesim and Filtersim algorithms honor absolute, or “hard” constraints from data acquired in wells or outcrops, and other interpreted trend maps of the reservoir under study. Training images are the main driver of any MPS approach. An issue raised implicitly by current MPS algorithms is how to generate training images. Training images are supposed to model or reproduce real geological features and should as much as possible be derived from existing geologically meaningful images. This requires research on statistical and image-processing methods that will allow use of images from any source: hand-drawn sketches, aerial photographs, satellite images, seismic volumes, geological object-based models, physical-scale models, or geological process-based models.

Categorically variable training images are easier to generate than continuously variable training images. An object-based approach is commonly used to generate training images with categorical variables. A region-based approach, combined with the addition of desired constraints, can be used to generate continuously variable training images (see Zhang, T., Bombarde, S., Strebelle, S., and Oatney, E., 2006, 3D porosity modeling of a carbonate reservoir using continuous multiple-point statistics simulation: SPE Journal v. 11, p. 375-379).

Representative Element Volumes

Referring to FIG. 5, Bear (1972) discussed the concept of representative element volume (REV) (see Bear, J., 1972, Dynamics of fluids in porous media: Elsevier, New York, 746 p.). Bear (1972) defined ΔUᵢ as a volume in a porous media, with a centroid of P. ΔUᵢ is considered to be much larger than a single pore or grain. ΔUᵥ is the volume of void space, and nᵢ is the ratio of void space to volume, i.e., the fractional porosity. At large values of ΔUᵢ, there are minimal fluctuations of porosity as a function of volume (FIG. 5). However, as volume decreases, fluctuations in porosity increase, especially as ΔUᵢ approaches the size of a single pore, which has fractional porosity of 1. If the centroid P happens to lie in a grain, porosity is 0 when ΔUᵢ=0 (dashed line in FIG. 5). The value ΔUₒ is defined as the REV, below which fluctuations of porosity are significant, and above which fluctuations of porosity are minimal. In brief, the dimensions of ΔUₒ are sufficient so that “the effect of adding or subtracting one or several pores has no significant influence on the value of n” (Bear, 1972). The excursion for inhomogeneous media from the plateau at high ΔUᵢ volumes shown in FIG. 5 relates to layered media.

Using the REV approach, the porous medium is replaced by “a fictitious continuum: a structureless substance, to any point of which we can assign kinematic and dynamic variables and parameters that are continuous functions of the spatial coordinates of the point and of time” (Bear, 1972). The REV for porosity may differ from the REV for permeability, or other parameters.

It is noted Fredrich et al. (1995), Fredrich et al. (1999), and O'Connor and Fredrich (1999) used laser scanning confocal microscopy (LSCM) for 3D pore modeling and flow modeling (see Fredrich, J. T., Menendez, B., and Wong, T. F., 1995, Imaging the pore structure of geomaterials: Science, v. 268, p. 276-279). However, their flow models are unrealistic because they imaged thin slabs of rock, up to 200μ in thickness, such that they failed to image the tops and bottoms of grains and pores. In other words, their grain sizes were too coarse for the LSCM technique, resulting in that they could not quantify true 3D pore geometry.

Further, Okabe and Blunt (2004, 2005) used multi-point statistics (MPS) to generate 3D pore systems from 2D thin sections. However, they assumed that the 2D horizontal view was the same as the 2D vertical view, and proceeded to generate their model. Because of this flawed assumption, their model does not capture rock heterogeneity, and does not depict true 3D pore geometry.

U.S. Pat. No. 4,702,607 discloses a 3-dimensional structure viewer of a transparent object, but not discuss a porous media. U.S. Pat. No. 6,750,974 discusses 3D imaging of droplets, but does not discuss a porous media.

Therefore, there is a need for methods that overcome the above noted limitations of the prior art. By non-limiting example, methods that can utilize applications of LSCM and MPS as a method to build 3D digital models of porous media.

### SUMMARY OF THE INVENTION

According to embodiments of the invention, the invention includes a method for characterizing a three-dimensional (3D) sample of porous media using at least one measuring tool that retrieves two or more set of transmitted measured data at two or more depths of the sample, such that the retrieved two or more set of transmitted measured data is communicated to a processor and computed in at least one multi-point statistical (MPS) model. The method comprising: (a) retrieving a first and a second set of transmitted measured data from the two or more set of transmitted measured data wherein the second set of transmitted measured data can be retrieved adjacent to the first set of transmitted measured data and at a depth different than the first set of transmitted measured data; (b) using at least one noise-reduction algorithm to identify noise data in the retrieved first and second transmitted measured data so that the identified noise data can be removed, wherein the at least one noise-reduction algorithm includes a median-filtering algorithm; (c) using the two or more transmitted measured data to create a training image and to produce a 3D sample imaging log that is communicated to the processor, and inputting the training image in the at least one MPS model; (d) performing the pattern-based simulations from the training image using a voxel-based template that is applied to the training image; and (e) constructing the at least one MPS model from the pattern-based simulations from the training image so as to build one or more complete-3D-sampling model of the sample.

According to aspects of the invention, the median-filtering algorithm provides for averaging data or smoothing data from the retrieved one or more set of transmitted measured data, so as to remove a portion of noise data. Further, the two or more set of transmitted measured data can be at least three or more set of data at three or more depths of the sample. Further still, a pore size of the at least one 3D sample model can be in a range approximately 0.1 micron (μ) to approximately two or more hundred microns (μ).

According to aspects of the invention, the sample can be made into a pore cast whereby at least one portion of the sample is removed using one of an acid or a chemical, whereby the two or more set of transmitted measured data is retrieved. The at least one measuring tool can be a transmitted laser scanning confocal microscope having a depth of penetration of at least two grain diameters of the sample. Further still, the sample can be shaped as one of a uniform geometric shape, a non-uniform geometric shape or some combination thereof. The 3D sample imaging log can include one of processed raw data that consists of transmitted measured values, historical data or some combination thereof.

According to aspects of the invention, the one or more complete-3D-sampling image can be used to build at least one 3D sample model related to a representative element volume (REV) of the at least one 3D sample, whereby the REV can be determined by: (a) a sub-sample volume of the MPS simulation; (b) computing a parameter, such as one of porosity, permeability or both, for each sub-sample volume of the MPS simulation; (c) computing a variance or a variability of the determined parameters for all sub-sample volumes of the MPS simulation; and (d) identifying the sub-sample volume as an REV if the variance is within verified limits, for example, plus or minus 5% of the mean value of the determined parameters for all sub-sample volumes of the MPS simulation.

According to aspects of the invention, the 3D sample imaging log can include plotting a digital file of the one or more complete-3D-sampling image of the sample onto one of a digital media or hard copy media. The sample can be from a geological formation and shaped as one of a rectangle shape, a cylindrical shape, a shape having at least one planar surface or some combination thereof.

According to aspects of the invention, the two or more set of transmitted measured data includes data gathered from the at least one measuring tool using a transmitted light.

According to embodiments of the invention, the invention includes a method for characterizing a three-dimensional (3D) sample of porous media to identify flow properties of the sample whereby one or more flow simulation model is generated from two or more set of transmitted measured data provided by at least one measuring tool in combination with at least one multi-point statistical (MPS) model. The method comprises: (a) retrieving the two or more set of transmitted measured data which includes data retrieved at two or more adjacent surfaces wherein each surface of the two or more adjacent surfaces can be at a different depth of the sample; (b) using at least one noise-reduction algorithm to identify noise data in the retrieved two or more set of transmitted measured data so that the identified noise data can be removed, such that the at least one noise-reduction algorithm includes a median-filtering algorithm; (c) selecting multiple depth-defined surface portions of the sample from the two or more set of transmitted measured data to create a training image so as to produce a 3D sample imaging log that can be communicated to the processor, and inputting the training image in the at least one MPS model; (d) performing the pattern-based simulations from the training image using a voxel-based template that is applied to the training image; and (e) constructing the at least one MPS model from the pattern-based simulations from the training image so as to build one or more complete-3D-sampling model of the sample such that the one or more complete-3D-sampling model provides for constructing one or more flow simulation model to assist in determining flow properties of the sample.

According to aspects of the invention, the invention includes historical data that has preexisting larger or smaller scale data or preexisting data of any scale.

According to aspects of the invention, the invention includes the median-filtering algorithm provides for averaging data or smoothing data from the retrieved one or more set of transmitted measured data, so as to remove a portion of noise data. The two or more set of transmitted measured data can be at least three or more set of data at three or more depths of the sample. A pore size of the at least one 3D sample model can be in a range approximately 0.1 micron (μ) to approximately two or more hundred microns (μ).

According to aspects of the invention, the invention includes the sample can be subject to a vacuum and impregnated with a fluorescent epoxy under a pressure before the two or more set of transmitted measured data can be retrieved. The sample can be made into a pore cast whereby at least one portion of the sample is removed using one of an acid or a chemical, whereby the two or more set of transmitted measured data is retrieved. The sample can be shaped as one of a uniform geometric shape, a non-uniform geometric shape or some combination thereof. The sample imaging log includes one of processed raw data that consists of transmitted measured values and non-measured values. The at least one measuring tool can be a transmitted laser scanning confocal microscope having a depth of penetration of at least two grain diameters of the sample. Wherein each surface of the two or more adjacent surfaces at different depths of the sample can be stacked having flat aspect ratios, such as 20 micron (μ) thick by 210×210 microns (μ) or larger in an area.

According to aspects of the invention, the invention includes the retrieved two or more set of transmitted measured data can be used to provide a training image to be used to assist in creating the at least one MPS model. A size and a shape of the at least one MPS model can be one of increased, modified or both from an original training image size and shape. The increased at least one MPS model size and shape can be one of a uniform geometric shape, a non-uniform geometric shape, or any combination thereof, so that the enlarged sizes and modified shapes reduce boundary effects so as to ensure for accurate flow modeling of the sample.

According to aspects of the invention, the invention includes the at least one MPS model can be used directly for flow simulation, for example, using a lattice-Boltzmann modeling approach. The at least one MPS model can be converted to a pore-network model, such that a flow simulation can be run using, for example, an invasion-percolation modeling approach.

According to aspects of the invention, the invention includes the one or more complete-3D-sampling image is used to build at least one 3D sample model related to a representative element volume (REV) of the at least one 3D sample, whereby the REV can be determined by: (a) a sub-sample volume of the MPS simulation; (b) computing a parameter, such as one of porosity, permeability or both, for each sub-sample volume of the MPS simulation; (c) computing a variance or a variability of the determined parameters for all sub-sample volumes of the MPS simulation; and (d) identifying the sub-sample volume as an REV if the variance is within verified limits, for example, plus or minus 5% of the mean value of the determined parameters for all sub-sample volumes of the MPS simulation.

According to aspects of the invention, carbonate rocks have complex pore systems, ranging in size from caverns to submicron-scale micropores. 3D digital rock models of fine-scale porosity (<1 mm) are generally made using X-ray micro-Computed Tomography (CT) scans, with resolution limits on the order of a few microns. Transmitted laser scanning confocal microscopy (LSCM) and multi-point statistics (MPS) provide an alternative, high-resolution (0.1 μ) method to build 3D digital rock models of appropriate size and shape for pore-network construction and flow modeling. Even though aspects of the invention are directed to carbonate rocks, it is conceived that the methods can apply to digital models built for any porous media.

According to aspects of the invention, confocal microscopy uses point illumination and a pinhole placed in front of a detector to eliminate out-of-focus information. Because each measurement is a single point, confocal devices perform scans along grids of parallel lines to provide 2D images of sequential planes at specified depths within a sample. According to aspects of the invention, by-non-limiting example, LSCM is applied to rock samples impregnated with fluorescing epoxy. Reflected light intensity indicates the physical location of pore spaces. Samples can be standard thin sections (30-μ thick), or rock chips of any thickness. Samples can be composed of rock and epoxy, or they may be pore casts where the rock has been removed by acid.

Further, according to aspects of the invention, reflected light can be absorbed and scattered by the material above the focal plane, therefore the depth of penetration of LSCM can be limited to 10-250μ in rocks, and 500μ in pore casts. LSCM data stacks commonly have flat aspect ratios, for example, 20μ thick by 210×210μ or larger in area. According to aspects of the invention, and by-non-limiting example, to build valid 3D models of physical pore systems, the depth of penetration should be at least 2 typical grain diameters. Therefore, a grain-size limitation exists for LSCM imaging.

According to aspects of the invention, 3D digital rock models constructed from stacked LSCM scans can be used as training images for multi-point statistical (MPS) modeling. MPS creates conditional simulations that use known results as fixed or “hard” data. According to at least one aspect of the invention, the method includes MPS to create thick (mm-scale), high-resolution (better than 1μ) digital rock models, suitable for pore-network modeling and/or flow simulation. Enlarged models avoid boundary effects that compromise flow-modeling results. MPS models can be used to address the question: What model size is needed to capture heterogeneity within a given rock type? Because MPS models are unconstrained by size or shape, we can use them to test the concept of representative element volume (REV). REV is the smallest volume that can be modeled to yield consistent results, within acceptable limits of variance of the modeled property, for example, porosity.

According to aspects of the invention, it can be possible to successfully image vertical depths as great as 500μ using pore casts of carbonate rocks, where the rock material has been removed with acid. In order to build valid 3D models of physical pore systems, it is best when the depth of penetration is at least 2 typical grain diameters. Because of the limited depth of penetration, it can be common to record images that are relatively flat in aspect ratio, for example, 20μ thick and 210×210μ in area. For this reason, it is important to be able to use statistical algorithms to build enlarged numerical models of pore systems. Such models can then be used for pore-network modeling and/or flow simulation.

According to aspects of the invention, and referring to FIG. 4, it can be useful to compare magnification vs. resolution for various techniques used to image porous media. In particular, FIG. 4 shows the magnification vs. resolution for different types of microscopes. Abbreviations: MicroCT=micro-computed tomography (CT) scans; LSCM=laser scanning confocal microscopy; SEM=scanning electron microscopy; AFM=atomic force microscopy (see Jia, J., 2007, personal communication). Note that the aspect of the invention includes a range of resolution for LSCM that occurs between 0.1 and 50μ. For example, if we want to image pores at least 2 grain diameters below the rock surface, we should apply LSCM to rocks with grain size of 25μ or less. If we use pore casts, grain size is less of a constraint, and we can apply LSCM to rocks with grain sizes of 250μ or less.

According to aspects of the invention, digital images of pore systems acquired by LSCM are directly used as training images, and MPS (Snesim algorithm) is used to generate larger realizations of the 3D pore systems. Such realizations are suitable for pore-network modeling and flow simulations, assuming that the measured pore systems are representative of a particular rock type. In some rocks, the pores may be too large for the LSCM technique. This occurs, for example, in thin sections where the average grain size is more than 15μ. This is because we want to see at least 2 grain diameters below the rock surface to generate true 3D images. Grain-size limitations can be reduced if the mineral material is eliminated, for example, by using acid to create pore casts. With pore casts, rocks with grain diameters up to 250μ can be imaged. The principle advantage of MPS can be that we can create enlarged models that reduce boundary effects inherent with smaller models when we run flow simulations.

Further features and advantages of the invention will become more readily apparent from the following detailed description when taken in conjunction with the accompanying drawings.

### BRIEF DESCRIPTION OF THE DRAWINGS

The application file contains at least one drawing executed in color. Copies of this patent or patent application publication with color drawings will be provided by the Office upon request and payment of the necessary fee.

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows prior art, the basic principles of laser confocal microscopy, features include detector pinhole and parallel focal planes at different levels in the specimen (see Olympus (2009);

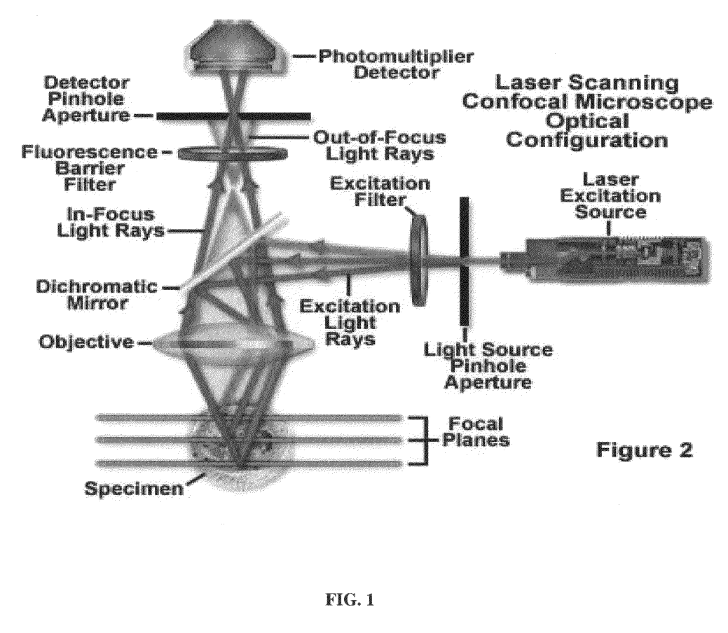

FIG. 2 shows prior art, the comparison of conventional widefield (left) vs. confocal (right) microscopy, wherein the confocal image is a high-resolution measurement of a single focused point on the specimen (see Olympus (2009);

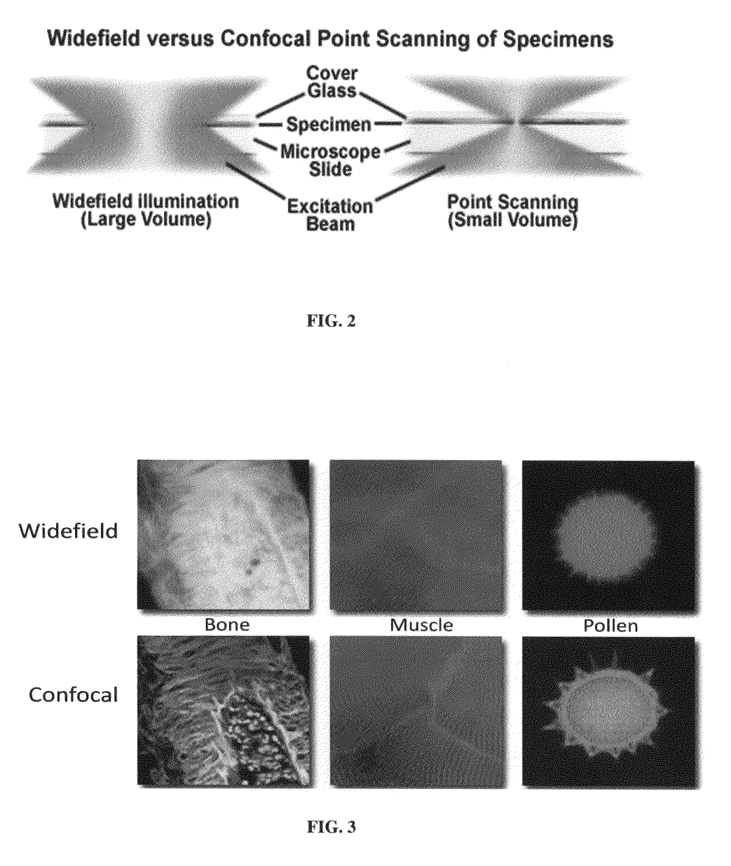

FIG. 3 shows prior art, images of biological specimens show comparison between conventional widefield (top) vs. confocal (bottom) microscopy (see Olympus (2009);

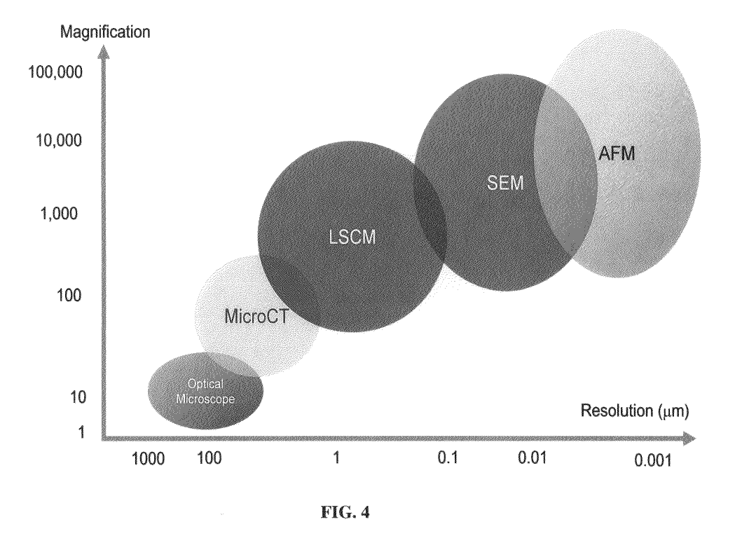

FIG. 4 shows prior art, magnification vs. resolution for different types of microscopes. Abbreviations: MicroCT=micro-computed tomography (CT) scans; LSCM=laser scanning confocal microscopy; SEM=scanning electron microscopy; AFM=atomic force microscopy (see Jia (2007));

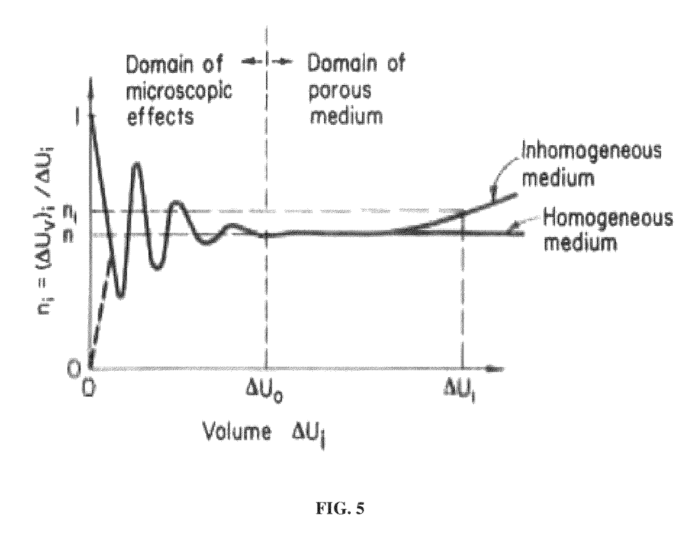

FIG. 5 shows prior art, definition of representative element volume (REV), ΔUᵢ is the bulk volume of a porous media, much larger than a single pore or grain. ΔUᵥ is the volume of void space, and nᵢ is the fractional porosity. At large values of ΔUᵢ, minimal fluctuations occur in porosity as a function of volume (see Bear (1972));

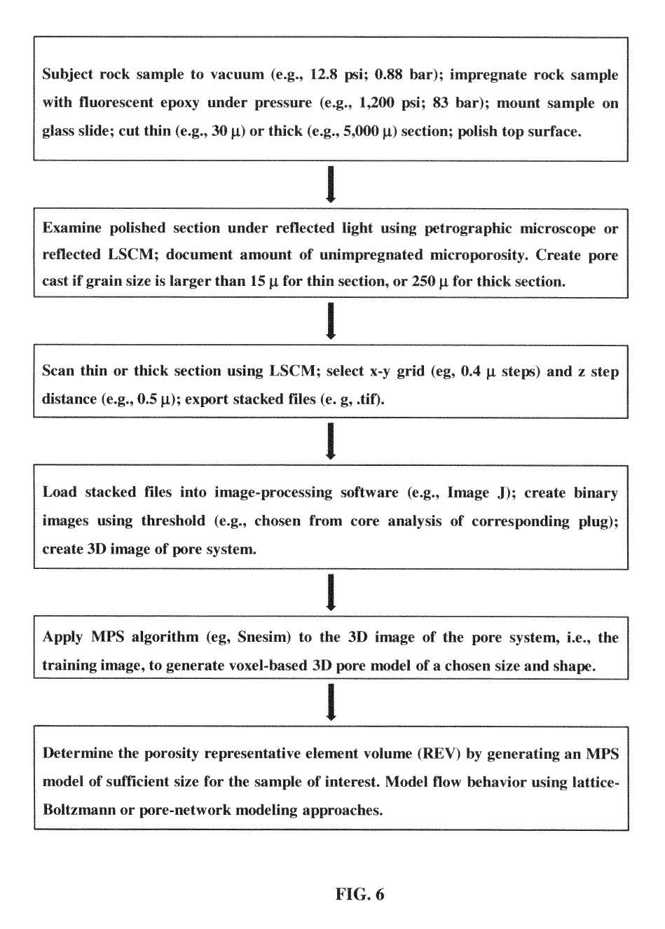

FIG. 6 shows a flow chart for laser scanning confocal microscopy (LSCM), multi-point statistics (MPS) modeling, and representative element volume (REV) determination, according to aspects of the invention;

FIG. 7 shows a thin section of crystalline dolomite, wherein the porosity is purple in color because fluorescent dye (Rhodamine B) was added to the epoxy before it was used to impregnate the rock, according to aspects of the invention;

FIGS. 8A-8C, wherein FIG. 8A shows raw data shows reflected light intensity from transmitted LSCM, purple colors represent the mineral matrix (rock); reds, yellows, greens, and blues represent the pores; FIG. 8B binary view of FIG. 8A shows rock as gray and pores as black, with an area is 210×210μ; image segmentation of FIG. 8A results in 8.5% porosity; FIG. 8C Binary view of FIG. 8A shows rock as gray and pores as black. Area is 210×210μ. Image segmentation of FIG. 8A results in 26% porosity, according to aspects of the invention;

FIGS. 9A-9I shows a successive binary LSCM scans (top, FIG. 9A through bottom, FIG. 9I) show rock as gray and pores as black with average porosity being 8.5%. Area is 210×210μ. Vertical spacing between each scan is 0.5μ., according to aspects of the invention;

FIGS. 10A and 10B, wherein FIG. 10A shows a 3D pore distribution of the original digital sample (porosity=8.5%), as scanned by LSCM, built from images shown in FIGS. 8B and 9A-9I; volume is 210×210×20μ; 256×256×60 voxels FIG. 10B shows a 3D view of the MPS model that used FIG. 10A as a training image; pores are yellow and rock matrix is blue; volume is 210×210×60μ; 256×256×180 voxels, according to aspects of the invention;

FIGS. 11A and 11B, wherein 11A shows a 3D pore distribution of the original digital sample (porosity=26%), as scanned by LSCM, built from images shown in FIG. 8C; volume is 210×210×20μ; 256×256×60 voxels; FIG. 11B shows a 3D view of the MPS model that used FIG. 11A as a training image, wherein the pores are yellow and rock matrix is blue; volume is 210×210×60μ; 256×256×180 voxels, according to aspects of the invention;

FIG. 12 shows the porosity representative element volume (REV) that can be estimated using the following procedure: (1) randomly select multiple, non-overlapping blocks of uniform size from a measured or modeled sample, (2) plot individual block porosity vs. corresponding block volume, and (3) determine the variance between samples for a given block volume, according to aspects of the invention;

FIGS. 13A-13C shows, wherein 13A shows a pore-network model derived from MPS model with 8.5% porosity (FIG. 10B), such that the balls represent pore bodies; sticks represent pore throats. FIG. 13B shows a pore-network model derived from MPS model with 26% porosity (FIG. 11B). FIG. 13C shows a new pore-network model created by shrinking the model elements in FIG. 13B to obtain 8.5% porosity while maintaining pore connectivity and using the same model dimensions, according to aspects of the invention; and

FIGS. 14A and 14B, wherein FIG. 14A shows the petrophysical properties calculated from pore-network model shown in FIG. 13C; FIG. 14B shows the resistivity index (RI) vs. water saturation (S_{w}), according to aspects of the invention.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice. Further, like reference numbers and designations in the various drawings indicated like elements.

According to embodiments of the invention, the invention includes a method for characterizing a three-dimensional (3D) sample of porous media using at least one measuring tool that retrieves two or more set of transmitted measured data at two or more depths of the sample, such that the retrieved two or more set of transmitted measured data is communicated to a processor and computed in at least one multi-point statistical (MPS) model. The method comprising: (a) retrieving a first and a second set of transmitted measured data from the two or more set of transmitted measured data wherein the second set of transmitted measured data is retrieved adjacent to the first set of transmitted measured data and at a depth different than the first set of transmitted measured data; (b) using at least one noise-reduction algorithm to identify noise data in the retrieved first and second transmitted measured data so that the identified noise data is removed, wherein the at least one noise-reduction algorithm includes a median-filtering algorithm; (c) using the two or more transmitted measured data to create a training image and to produce a 3D sample imaging log that is communicated to the processor, and inputting the training image in the at least one MPS model; (d) performing the pattern-based simulations from the training image using a voxel-based template that is applied to the training image; and (e) constructing the at least one MPS model from the pattern-based simulations from the training image so as to build one or more complete-3D-sampling model of the sample.

Confocal microscopy uses transmitted laser light and a polished thin section or rock chip that is vacuum-pressure impregnated with fluorescing epoxy. The sample lies on a movable stage, and confocal scans produce an x-y grid of z-values that measure reflected light intensity in regularly spaced planes. Data processing involves loading stacked images into 3D visualization software, and analyzing 3D pore geometries. The smallest pores, a function of the spot size of the light source and the step distance of the profiles, are roughly 0.1μ in size. The largest pores are generally less than 100μ in size.

Published digital rock models have been constructed from 2D thin sections, scanning-electron microscope (SEM) images, computer-generated sphere packs, laser-scanning confocal microscope images, and various types of CTscans (conventional, microCT, and synchrotron-computed microtomography). CTscans, the most widely used approach, are 2-dimensional (2D) cross sections generated by an X-ray source that rotates around the sample. Density is computed from X-ray attenuation coefficients. Scans of serial cross sections are used to construct 3D images of the sample. Because the density contrast is high between rocks and fluid-filled pores, CT images can be used to visualize the rock-pore system. Resolutions are on the sub-millimeter to micron scale, depending on the device being used.

Multi-point statistics (MPS) are used to create simulations of spatial geological and reservoir property fields for reservoir modeling. These methods are conditional simulations that use known results, such as those measured in wellbores or rock samples, as fixed or “hard” data that are absolutely honored during the simulations. MPS uses 1D, 2D, or 3D “training images” as quantitative templates to model subsurface property fields. MPS modeling captures geological structures from training images and anchors them to data locations. These structures can be either a priori geological interpretations or conceptual models. In this study, stacked confocal scans are used as training images, and MPS is used to generate enlarged 3D pore volumes suitable for pore-network modeling and/or flow modeling.

According to aspects of the invention, by-non-limiting example, methods use a laser scanning confocal microscope (LSCM) to scan 2D planes through rock samples impregnated with fluorescing epoxy. Pore models are constructed from the scans, and these are used as training images for multi-point statistical (MPS) models. MPS realizations are then used for flow simulations, or they are converted into pore-network models that can in turn be used for flow simulations.

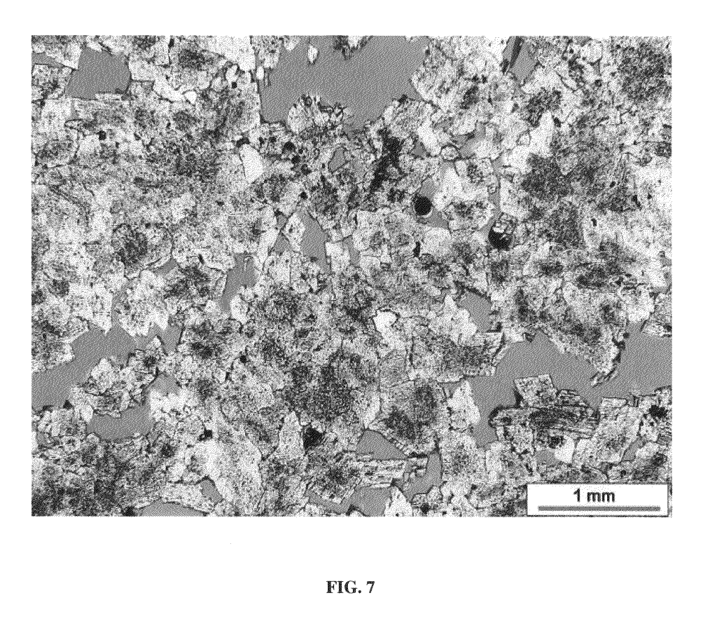

FIG. 6 shows, by-non-limiting example, a flow chart for laser scanning confocal microscopy (LSCM), multi-point statistics (MPS) modeling, and representative element volume (REV) determination. FIG. 6 shows the flow diagram that includes the following parts:

Part [1] Vacuum-Pressure Impregnate Rock Sample with Fluorescing Epoxy

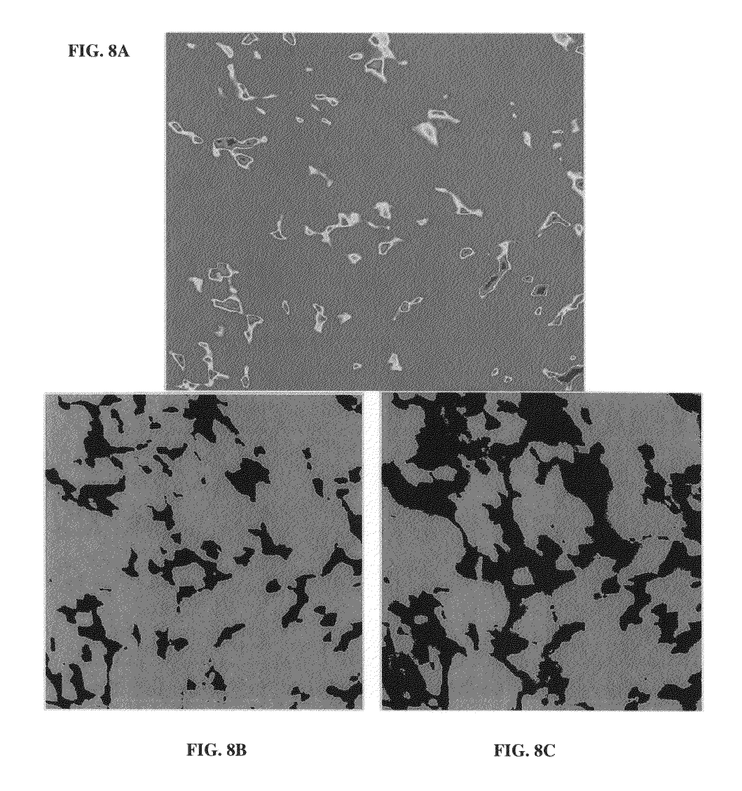

FIG. 7 shows a thin section of crystalline dolomite, wherein the porosity is purple in color because fluorescent dye (Rhodamine B) was added to the epoxy before it was used to impregnate the rock. Subjecting the clean, dry rock sample to a vacuum (for example, 12.8 psi; 0.88 bar), introduce epoxy that has been stained with fluorescent dye (for example, Rhodamine B, 1.5 to 200 mixture), and subject the combined sample and epoxy to high pressure (for example, 1,200 psi; 82.7 bar). This ensures impregnation of even the smallest connected pores. Low-viscosity, slow-curing epoxy is recommended. Mount the sample on a glass slide, cut to the appropriate thickness, for example, a thin section is 30μ, and a thick section is up to 5,000μ in thickness. Polish the top surface of the rock sample. FIG. 7 is a photomicrograph of a conventional thin section of a dolomite impregnated with Rhodamine B stained epoxy.

Part [2] Examine Polished Rock Sample Under Reflected Light

Still referring to FIGS. 6-7, using a conventional petrographic microscope with reflected light, a scanning electron microscope (SEM), or a reflected LSCM (for example, the Olympus (2009) LEXT OLS3000 microscope) to view the polished rock sample. Document and/or quantify the amount of unimpregnated pore space, because this provides a measure of the non-connected microporosity.

Still referring to FIGS. 6-7, MPS modeling is appropriate if the training images have a depth of penetration of at least 2 typical grain diameters. Otherwise, the training images are not truly 3D images. Create pore casts for samples with grain sizes larger than 15 m for thin sections and 250μ for thick sections. For limestones, use weak (for example, 10%) hydrochloric acid to remove rock material. For dolomites, use stronger hydrochloric acid. For sandstones, use hydrofluoric acid. Be sure the acid concentration is not high enough to cause vigorous bubbling, which can destroy delicate pore fabrics. Gently rinse the sample in de-ionized water, and immerse in an ultrasonic cleaner, if necessary.

Part [3] Scan Thin Section using LSCM

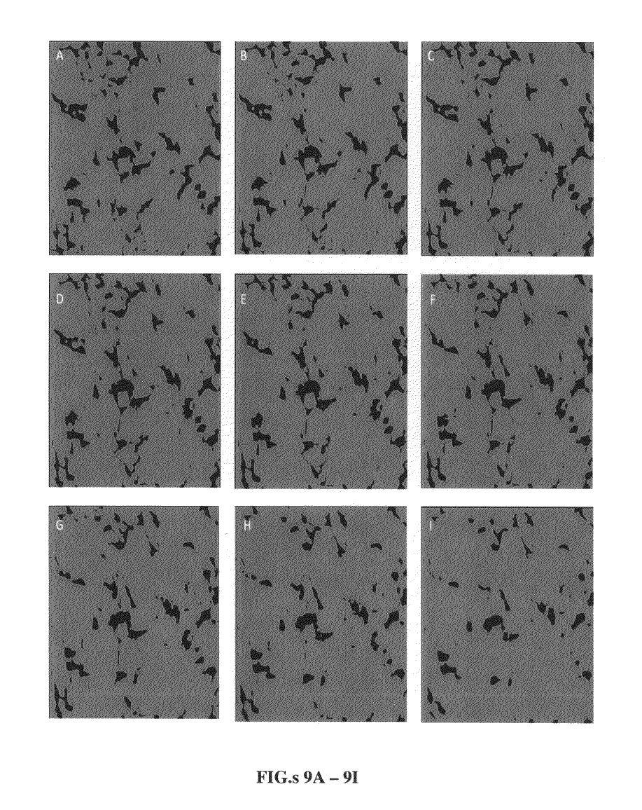

Referring to FIG. 8A, scan the thin or thick section, for example, using 0.4×0.4μ x-y steps and 0.5 m vertical (z) steps with a total scanned area of 210×210μ (FIG. 8A). In FIG. 8A, the raw data show the reflected laser light intensity at various focal planes taken through the sample. Save the LSCM scans as, for example, a stack of .tif files. In particular, FIG. 8A shows the raw data shows reflected light intensity from transmitted LSCM, wherein the purple colors represent the mineral matrix (rock); reds, yellows, greens, and blues represent the pores.

Part [4] Create Binary Images and 3D Visualization of Pore System

Referring to FIGS. 8B and 8C, wherein 8B shows the binary view of FIG. 8A whereby the rock are gray and pores as black, such that the area is 210×210μ. Image segmentation of FIG. 8A results in 8.5% porosity, wherein 8C shows a binary view of FIG. 8A whereas the rock is gray and pores as black and the area is 210×210μ. Image segmentation of FIG. 8A results in 26% porosity.

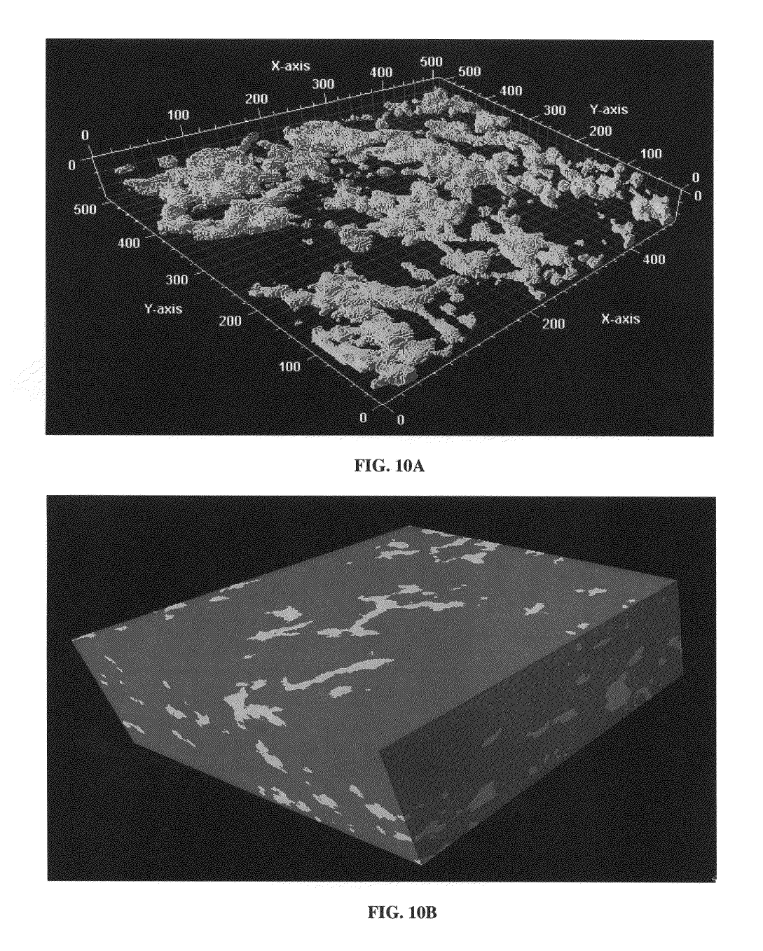

Referring to FIGS. 8B-9I, process the stack of LSCM data using image analysis software (for example, Image J). Create binary images by choosing a threshold to match, for example, measured porosity in the corresponding core plug (FIGS. 8B and 8C). Higher thresholds ensure higher 3D connectivity of the pore system. FIG. 9 shows successive binary LSCM images through a thin section of dolomite. In particular, FIGS. 9A-9I show successive binary LSCM scans (top, A through bottom, I) show rock as gray and pores as black with average porosity being 8.5%. Area is 210×210μ. Vertical spacing between each scan is 0.5 μ.

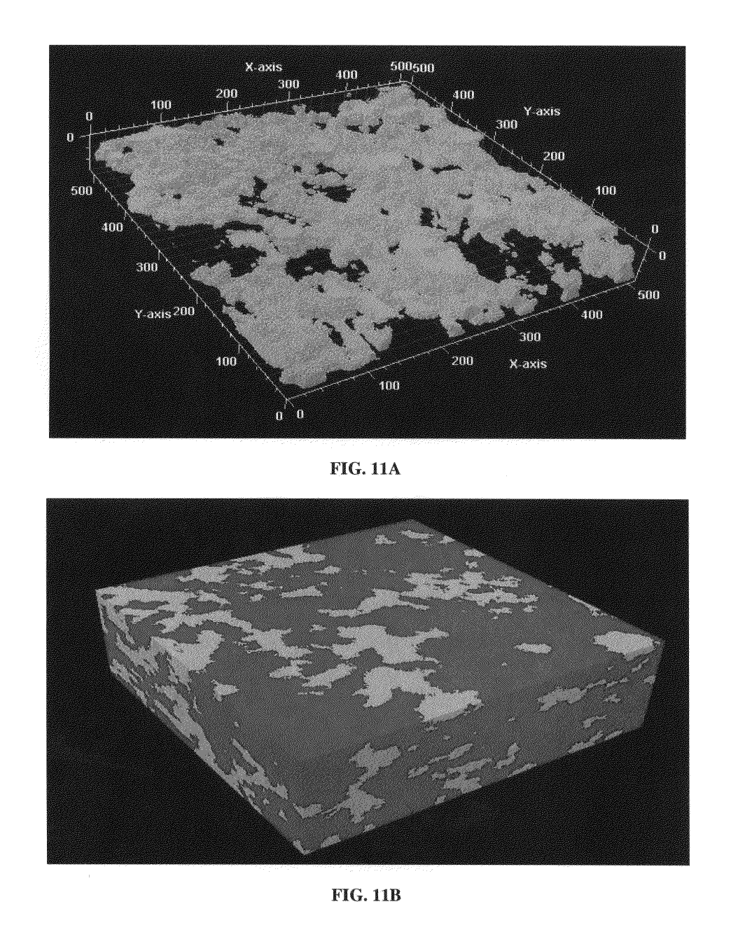

Referring to FIGS. 10A and 10B, wherein FIG. 10A shows a 3D pore distribution of the original digital sample (porosity=8.5%), as scanned by LSCM, built from images shown in FIGS. 8B and 9. Volume is 210×210×20μ; 256×25×60 voxels. FIG. 10B shows a 3D view of the MPS model that used FIG. 10A as a training image. Pores are yellow and rock matrix is blue. Volume is 210×210×60μ; 256×256×180 voxels.

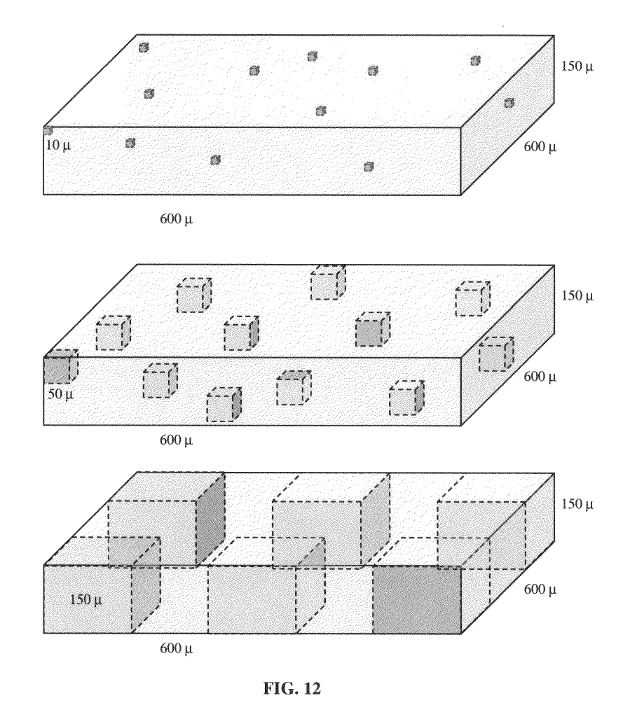

FIGS. 11A and 11B, wherein FIG. 11A shows a 3D pore distribution of the original digital sample (porosity=26%), as scanned by LSCM, built from images shown in FIG. 8C. Volume is 210×210×20μ; 256×256×60 voxels. FIG. 11B 3D shows the view of the MPS model that is used FIG. 11A as a training image wherein the pores are yellow and rock matrix is blue. Volume is 210×210×60μ; 256×256×180 voxels.

FIGS. 10A and 11A show 3D pore systems generated from LSCM scans using thresholds that provided 8.5% and 26% porosities, respectively.

Part [5] Generate MPS Simulations

Still referring to FIGS. 10A-11B, using MPS algorithms (for example, Snesim) to generate 3D realizations of the pore system (FIGS. 10B and 11B). The training image is the pore system measured by LSCM in Part [3] and binarized and visualized in Part [4]. Note that the vertical dimension has been arbitrarily increased by 3× in the MPS models of FIGS. 10B and 11B. The size of the MPS model volume is chosen so that it is large enough to avoid boundary effects. Ideally, the modeled MPS volume is large enough to be a representative element volume ( REV, next section). Further, it is noted that there is a relationship between the size of the REV and the measuring instrument. For example, LSCM is ideally suited to samples with grain diameters of 0.1 to 50μ. If we use pore casts, grain diameters can be as much as 250μ. If grain diameters in a particular rock are larger than the appropriate diameters, a different measuring technique is necessary, for example, microCTscan.

Part [6] Determine the Porosity REV and Perform Flow Modeling

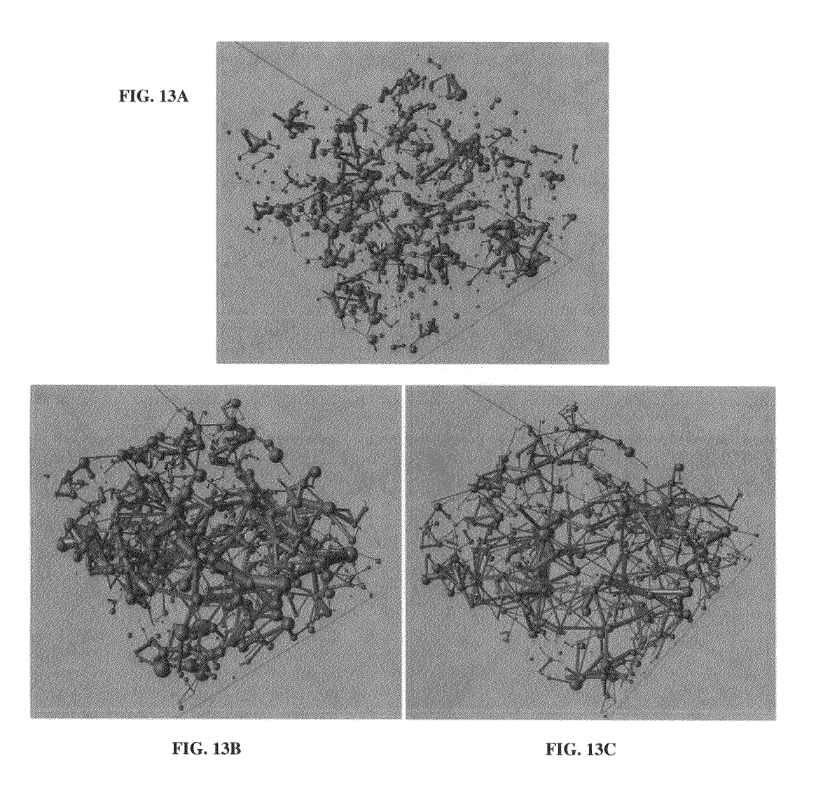

Referring to FIG. 12, the concept of REV can be applied to MPS models generated in this study. MPS can be used to generate a model of any size and shape. The only limitation is the amount of available random access memory (RAM). In particular, FIG. 12 shows the porosity representative element volume (REV) that can be estimated using the following procedure: (1) randomly select multiple, non-overlapping blocks of uniform size from a measured or modeled sample, (2) plot individual block porosity vs. corresponding block volume, and (3) determine the variance between samples for a given block volume. When variance falls below a chosen threshold, the corresponding volume is the porosity REV of the rock under study. If variance does not fall below the chosen threshold, then heterogeneity has not been captured by the total measured or modeled volume, and a larger volume must be measured or modeled. Further, FIG. 12 shows a modeled volume of 600×600μ in area, by 150μ in thickness. Smaller sub-volumes, for example, 10, 50, or 150μ cubes, could be extracted from the modeled volume, and their porosities could be determined. All sub-volumes must be independent, non-overlapping cubes. If the porosity variance is less than a chosen cutoff, for example ±5%, then that volume can be used as the REV. For the purpose of flow modeling, the REV is sufficient to yield representative simulation results.

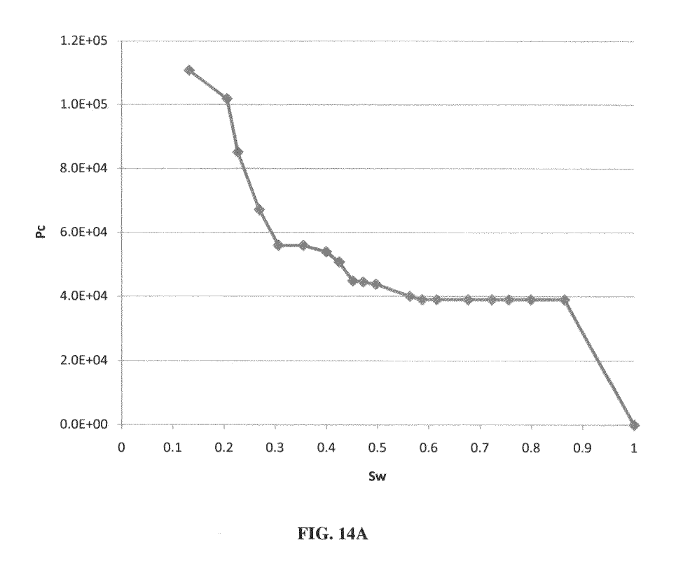

Referring to FIGS. 13A and 13B, the flow modeling can be done using lattice-Boltzmann approaches on the digital pore model itself. Alternatively, flow modeling can be done on pore-network models generated from the digital pore model. FIGS. 13A and 13B show pore-network models generated using thresholds that provided 8.5% and 26% porosities, respectively, in the 3D models (see FIGS. 10B and 11B). Further, the balls represent pore bodies; sticks represent pore throats. Note the abundance of non-connected, isolated pores. Modeled volume is 210×210×60μ; 256×256×180 voxels. FIG. 10B shows the pore-network model derived from MPS model with 26% porosity (FIG. 11B), wherein there are fewer non-connected, isolated pores. FIG. 13C new pore-network model created by shrinking the model elements in FIG. 13B to obtain 8.5% porosity while maintaining pore connectivity and using the same model dimensions. Note higher connectivity and fewer isolated pores in FIG. 13B. If the actual porosity is 8.5%, for example, the balls and sticks can be proportionally shrunk after model generation, as shown in FIG. 13C. This preserves connectivity and matches known porosity.

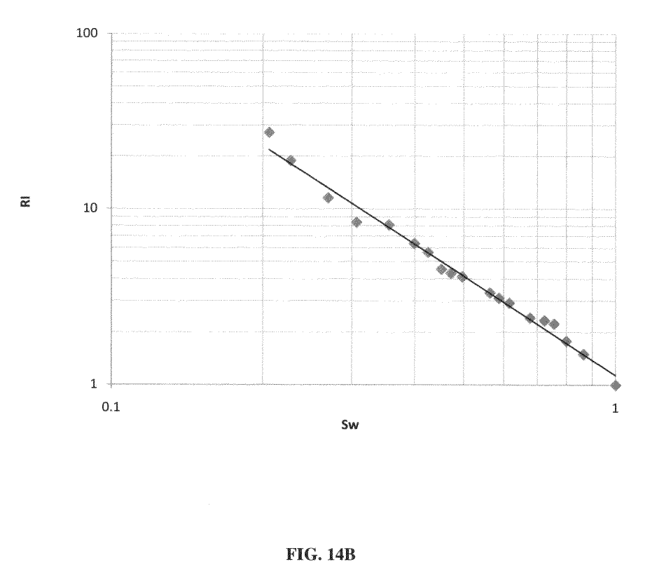

Referring to FIGS. 14A and 14B, wherein FIG. 14A shows petrophysical properties calculated from pore-network model shown in FIG. 13C. Further, FIG. 14A shows capillary pressure (P_{c}, Pascal) vs. water saturation (S_{w}). FIG. 14B resistivity index (RI) vs. water saturation (S_{w}). RI is defined as the ratio between resistivity of the partially water-saturated vs. the fully water-saturated sample (Rₜ/Rₒ). Saturation exponent n=1.87; cementation exponent m=1.63; formation factor F=55. Calculated absolute permeability k=4.2 md.

Still referring to FIGS. 14A and 14B show results of petrophysical analyses run on the pore-network model of FIG. 13C. Plots show capillary pressure (P_{c}) and electrical resistivity index (RI) vs. water saturation (S_{w}). Resistivity index is defined as the ratio between Rₜ and Rₒ, where Rₜ is the resistivity of the partially water-saturated medium, and Rₒ is the resistivity of the fully water-saturated medium. Modeled results can be compared to lab results to help choose appropriate thresholds and cutoffs during model generation.

According to aspects of the invention, and by-non-limiting example, methods of the invention provide for a complete, integrated workflow to image, process, and generate physical pore systems, construct pore-network models, run flow simulations, and compute representative element volumes (REV) in porous media, with pores as small as 0.1 m in size. Further, the limited depth of penetration of LSCM can control the grain size of rocks that can be scanned. Further, in order to build valid 3D models of physical pore systems, it mostly likely important to have a depth of penetration of at least 2 typical grain diameters. Therefore, it is recommended to first confirm that the technique is suitable for the grain sizes present in the sample. Further still, the prior art have what is so-called 3D pore systems that looks like fences which circle the grains, however the aspects of the depth concept is not worked out nor is there disclosed a perceived solution. It is noted that the limited depth of penetration of LSCM can be increased by using pore casts, where the rock material is dissolved with acid. Further, LSCM data has a low aspect ratio in terms of thickness vs. area, which means, most 3D LSCM scans are broad and thin. Thus, we use LSCM data as a training image for MPS, so as to greatly increase the size and shape of the modeled pore system. This allows for there to be minimize boundary effects, thereby ensuring more reliable flow modeling results in 3D. Because it is possible to generate pore systems of any size and shape, it means that it is possible to compute REV's to obtain the minimum volume which is needed to model to properly capture heterogeneities in the original rock.

One or more embodiments of the present invention have been described. Nevertheless, it will be understood that various modifications may be made without departing from the spirit and scope of the invention. It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method for characterizing a three-dimensional (3D) sample of porous media using at least one measuring tool that retrieves two or more set of transmitted measured data at two or more depths of the sample, such that the retrieved two or more set of transmitted measured data is communicated to a processor and computed in at least one multi-point statistical (MPS) model, the method comprising:
a) retrieving a first and a second set of transmitted measured data from the two or more set of transmitted measured data wherein the second set of transmitted measured data is retrieved adjacent to the first set of transmitted measured data and at a depth different than the first set of transmitted measured data;
b) using at least one noise-reduction algorithm to identify noise data in the retrieved first and second transmitted measured data so that the identified noise data is removed, wherein the at least one noise-reduction algorithm includes a median-filtering algorithm;
c) using the two or more transmitted measured data to create a training image and to produce a 3D sample imaging log that is communicated to the processor, and inputting the training image in the at least one MPS model;
d) performing the pattern-based simulations from the training image using a voxel-based template that is applied to the training image; and
e) constructing the at least one MPS model from the pattern-based simulations from the training image so as to build one or more complete-3D-sampling model of the sample.

2. The method according to claim 1, wherein the median-filtering algorithm provides for averaging data or smoothing data from the retrieved one or more set of transmitted measured data, so as to remove a portion of noise data.

3. The method according to claim 1, wherein the two or more set of transmitted measured data is at least three or more set of data at three or more depths of the sample.

4. The method according to claim 1, wherein a pore size of the at least one 3D sample model is in a range approximately 0.1 micron (μ) to approximately two or more hundred microns (μ).

5. The method according to claim 1, wherein the sample is subject to a vacuum and impregnated with a fluorescent epoxy under a pressure before the two or more set of transmitted measured data is retrieved.

6. The method according to claim 1, wherein the sample is made into a pore cast whereby at least one portion of the sample is removed using one of an acid or a chemical, whereby the two or more set of transmitted measured data is retrieved.

7. The method according to claim 1, wherein the at least one measuring tool is a transmitted laser scanning confocal microscope having a depth of penetration of at least two grain diameters of the sample.

8. The method according to claim 1, wherein the sample is shaped as one of a uniform geometric shape, a non-uniform geometric shape or some combination thereof.

9. The method according to claim 1, wherein the 3D sample imaging log includes one of processed raw data that consists of transmitted measured values, historical data or some combination thereof.

10. The method according to claim 1, wherein the one or more complete-3D-sampling image is used to build at least one 3D sample model related to a representative element volume (REV) of the at least one 3D sample, whereby the REV is determined by: (a) a sub-sample volume of the MPS simulation; (b) computing a parameter, such as one of porosity, permeability or both, for each sub-sample volume of the MPS simulation; (c) computing a variance or a variability of the determined parameters for all sub-sample volumes of the MPS simulation; and (d) identifying the sub-sample volume as an REV if the variance is within verified limits, for example, plus or minus 5% of the mean value of the determined parameters for all sub-sample volumes of the MPS simulation.

11. The method according to claim 1, wherein the 3D sample imaging log includes plotting a digital file of the one or more complete-3D-sampling image of the sample onto one of a digital media or hard copy media.

12. The method according to claim 1, wherein the sample is from a geological formation and shaped as one of a rectangle shape, a cylindrical shape, a shape having at least one planar surface or some combination thereof.

13. The method according to claim 1, wherein the two or more set of transmitted measured data includes data gathered from the at least one measuring tool using a transmitted light.

14. A method for characterizing a three-dimensional (3D) sample of porous media to identify flow properties of the sample whereby one or more flow simulation model is generated from two or more set of transmitted measured data provided by at least one measuring tool in combination with at least one multi-point statistical (MPS) model, the method comprising:
a) retrieving the two or more set of transmitted measured data which includes data retrieved at two or more adjacent surfaces wherein each surface of the two or more adjacent surfaces is at a different depth of the sample;
b) using at least one noise-reduction algorithm to identify noise data in the retrieved two or more set of transmitted measured data so that the identified noise data is removed, such that the at least one noise-reduction algorithm includes a median-filtering algorithm;
c) selecting multiple depth-defined surface portions of the sample from the two or more set of transmitted measured data to create a training image so as to produce a 3D sample imaging log that is communicated to the processor, and inputting the training image in the at least one MPS model; p1 d) performing the pattern-based simulations from the training image using a voxel-based template that is applied to the training image; and
e) constructing the at least one MPS model from the pattern-based simulations from the training image so as to build one or more complete-3D-sampling model of the sample such that the one or more complete-3D-sampling model provides for constructing one or more flow simulation model to assist in determining flow properties of the sample.

15. The method according to claim 14, wherein the median-filtering algorithm provides for averaging data or smoothing data from the retrieved one or more set of transmitted measured data, so as to remove a portion of noise data.

16. The method according to claim 14, wherein the two or more set of transmitted measured data is at least three or more set of data at three or more depths of the sample.

17. The method according to claim 14, wherein a pore size of the at least one 3D sample model is in a range approximately 0.1 micron (μ) to approximately two or more hundred microns (μ).

18. The method according to claim 14, wherein the sample is subject to a vacuum and impregnated with a fluorescent epoxy under a pressure before the two or more set of transmitted measured data is retrieved.

19. The method according to claim 14, wherein the sample is made into a pore cast whereby at least one portion of the sample is removed using one of an acid or a chemical, whereby the two or more set of transmitted measured data is retrieved.

20. The method according to claim 14, wherein the sample is shaped as one of a uniform geometric shape, a non-uniform geometric shape or some combination thereof.

21. The method according to claim 14, wherein the sample imaging log includes one of processed raw data that consists of transmitted measured values and non-measured values.

22. The method according to claim 14, wherein the at least one measuring tool is a transmitted laser scanning confocal microscope having a depth of penetration of at least two grain diameters of the sample.

23. The method according to claim 14, wherein each surface of the two or more adjacent surfaces at different depths of the sample are stacked having flat aspect ratios, such as 20 micron (μ) thick by 210×210 microns (μ) or larger in an area.

24. The method according to claim 14, wherein the retrieved two or more set of transmitted measured data is used to provide a training image to be used to assist in creating the at least one MPS model.

25. The method according to claim 24, wherein a size and a shape of the at least one MPS model is one of increased, modified or both from an original training image size and shape.

26. The method according to claim 25, wherein the increased at least one MPS model size and shape is one of a uniform geometric shape, a non-uniform geometric shape, or any combination thereof, so that the enlarged sizes and modified shapes reduce boundary effects so as to ensure for accurate flow modeling of the sample.

27. The method according to claim 14, wherein the at least one MPS model is used directly for flow simulation, for example, using a lattice-Boltzmann modeling approach.

28. The method according to claim 14, wherein the at least one MPS model is converted to a pore-network model, such that a flow simulation is run using, for example, an invasion-percolation modeling approach.

29. The method according to claim 14, wherein the one or more complete-3D-sampling image is used to build at least one 3D sample model related to a representative element volume (REV) of the at least one 3D sample, whereby the REV is determined by: (a) a sub-sample volume of the MPS simulation; (b) computing a parameter, such as one of porosity, permeability or both, for each sub-sample volume of the MPS simulation; (c) computing a variance or a variability of the determined parameters for all sub-sample volumes of the MPS simulation; and (d) identifying the sub-sample volume as an REV if the variance is within verified limits, for example, plus or minus 5% of the mean value of the determined parameters for all sub-sample volumes of the MPS simulation.
